(19) United States
(12) Patent Application Publication
(10) Pub. No.: US 2023/0058585 A1
(43) Pub. Date: Feb. 23, 2023

(54) EVENT FORECASTING SYSTEM, EVENT FORECASTING METHOD, AND STORAGE MEDIUM

(71) Applicant: OSAKA UNIVERSITY, Osaka (JP)

(72) Inventors: Takato HONDA, Osaka (JP); Yasuko SAKURAI, Osaka (JP); Koki KAWABATA, Osaka (JP); Yasushi SAKURAI, Osaka (JP)

(21) Appl. No.: 17/793,388

(22) PCT Filed: Jan. 12, 2021
(86) PCT No.: PCT/JP2021/000606

§ 371 Date: Jul. 16, 2022

(30) Foreign Application Priority Data
Jan. 22, 2020 (JP) 2020-008388

(51) Int. Cl. G06N 3/04

(52) U.S. Cl. CPC G06N 3/0472; G06N 3/0445

(57) ABSTRACT

An event forecasting system includes a feature amount extracting unit and a forecasting unit. The feature amount extracting unit continuously extracts model parameters {m, r, S, ⊝, F} of dynamic patterns in a time direction and a facility direction from a multidimensional time-series tensor X of time-series sensor data collected for every period n from a plurality of types d of sensors respectively disposed at a plurality w of facilities of a factory, and further sequentially featurizes the multidimensional time-series tensor X into summary information {Z, ε} including modeling information Z and error information ε of the modeling information by use of the model parameter {m, r, S, ⊝, F}. The forecasting unit outputs a probability p of occurrence of an alert label y at a predetermined time Iₛ ahead by use of the summary information {Z, ε} as an input.

### TECHNICAL FIELD

The present invention relates to event forecasting technology based on time-series sensor data.

### BACKGROUND ART

In recent years, the manufacturing industry has been promoting smarter manufacturing factories. Efforts to improve productivity from all aspects such as abnormality detection (Non Patent Literatures 25 and 32) or quality control (Non Patent Literature 14), of a device have been made by use of a large number of sensors to constantly monitor an operational status of a production line using a large number of sensors, accumulating, and analyzing such a status as time-series data. An important issue common to these efforts is effective acquisition of knowledge from collected large-scale data and development of future forecasting technology based on the knowledge. In particular, the time-series data obtained from the manufacturing factories is complex data with a plurality of domains (such as facilities, sensors, and time) and has a multidirectional pattern in many cases. The production line has common/different patterns for not only the time transitions of a plurality of work processes (patterns) but also each work line created by parallel work in a plurality of lines. In order to effectively identify the cause of a defective product or a facility failure, it is necessary to flexibly show such multidirectional and dynamic patterns, while at the same time clarifying a hidden causal relationship between the patterns.

In addition, a task assumed in a smart factory has a wider range of countermeasure options by grasping in advance an occurrence of each event such as a failure, a defect, or reduction in machining accuracy. In other words, the future forecasting technology of it is desirable for future forecasting technology of large-scale sensor data is desired to have longer-term forecasting ability (Non Patent Literature 15).

Research on a sensor data analysis has been advanced in various fields such as a database and data mining (Non Patent Literatures 2, 17, 19, 22, 24, and 25) . An auto regressive model (AR) and linearity dynamical systems (LDS) are representative techniques, and a large number of methods for analyzing and forecasting sensor data based on these techniques are present (Non Patent Literature 13).

Regime-Cast (Non Patent Literature 15) has an ability to estimate a non-linear dynamic system in real time from a large amount of multidimensional sensor data that continues to be generated and to continue to forecast a future in an adaptive manner. However, this method, although taking a sensor stream as an input and showing a high performance in forecasting an actual measured value of sensor data, does not support the forecasting of event data such as being normal/abnormal.

Moreover, pattern discovery and clustering for time-series big data are also important issues (Non Patent Literatures 8, 10, 11, 16, 28, 29, and 31) . Matsubara et al. (Non Patent Literature 18) proposed TriMine as a method of analyzing a large-scale event tensor. The TriMine, although classifying given data into a plurality of topics to detect a potential trend and pattern, targets discrete event data such as a click log on the Web, and is not able to show a dynamic pattern or a group (a regime) of a time-series sequence such as IOT sensor data, which is a different problem to handle. In addition, the TriMine does not have the ability to forecast an event.

Research on an analysis of non-linear dynamic characteristics based on Deep Neural Network is also active (Non Patent Literatures 3, 9, 26, and 27). In Non Patent Literature 21, Qin et al. have proposed a method to forecast a stock price with high accuracy by modeling an important dimension in input time series and an important dimension in a special space after dimension reduction over two hierarchical levels. On the other hand, in a task of forecasting an event that discontinuously occurs, as in this research, a method of modeling an occurrence intensity (Intensity) of the event is the mainstream (Non Patent Literatures 5, 6, 20, and 30) . For example, RMTPP (Non Patent Literature 5) proposes a non-linear model for forecasting the time and type of an event that occurs next, from the past event history. However, these methods target categorical data including only event history, and is not able to perform event forecasting by continuous data configured by actual measured values from a sensor.

### Citation List

### Non Patent Literatures

Non Patent Literature 1: C. M. Bishop. Pattern Recognition and Machine Learning (Information Science and Statistics). Springer, 2006.

Non Patent Literature 2: G. E. Box, G. M. Jenkins, and G. C. Reinsel. Time Series Analysis: Forecasting and Control. Prentice Hall, Englewood Cliffs, NJ, 3rd edition, 1994.

Non Patent Literature 3: P. Chen, S. Liu, C. Shi, B. Hooi, B. Wang, and X. Cheng. Neucast: Seasonal neural forecast of power grid time series. In IJCAI, pages 3315-3321, 2018.

Non Patent Literature 4: K. Cho, B. van Merrienboer, D. Bahdanau, and Y. Bengio. On the Properties of Neural Machine Translation: Encoder-Decoder Approaches. arXiv e-prints, page arXiv: 1409. 1259, Sep 2014.

Non Patent Literature 5: N. Du, H. Dai, R. Trivedi, U. Upadhyay, M. Gomez-Rodriguez, and L. Song. Recurrent marked temporal point processes: Embedding event history to vector. In KDD, pages 1555-1564, 2016.

Non Patent Literature 6: N. Du, Y. Wang, N. He, and L. Song. Time-sensitive recommendation from recurrent user activities. In NIPS, pages 3492-3500, 2015.

Non Patent Literature 7: J. G. DAVID FORNEY. The viterbi algorithm. In Proceedings of the IEEE, pages 268-278, 1973.

Non Patent Literature 8: D. Hallac, S. Vare, S. Boyd, and J. Leskovec. Toeplitz inverse covariance-based clustering of multivariate time series data. In KDD, pages 215-223, 2017.

Non Patent Literature 9: S. Hochreiter and J. Schmidhuber. Long short-term memory. Neural Comput., 9(8) :1735-1780, Nov. 1997.

Non Patent Literature 10: T. Honda, Y. Matsubara, R. Neyama, M. Abe, and Y. Sakurai. Multi-aspect mining of complex sensor sequences. In ICDM, 2019.

Non Patent Literature 11: K. Kawabata, Y. Matsubara, and Y. Sakurai. Automatic sequential pattern mining in data streams. In CIKM, pages 1733-1742, 2019.

Non Patent Literature 12: D. P. Kingma and J. Ba. Adam: A method for stochastic optimization. CoRR, abs/1412.6980, 2015.

Non Patent Literature 13: L. Li, J. McCann, N. Pollard, and C. Faloutsos. Dynammo: Mining and summarization of coevolving sequences with missing values. In KDD, 2009.

Non Patent Literature 14: Y. Li, J. Wang, J. Ye, and C. K. Reddy. A multi-task learning formulation for survival analysis. In KDD, pages 1715-1724, 2016.

Non Patent Literature 15: Y. Matsubara and Y. Sakurai. Regime shifts in streams: Realtime forecasting of co-evolving time sequences. In KDD, 2016.

Non Patent Literature 16: Y. Matsubara, Y. Sakurai, and C. Faloutsos. Autoplait: Automatic mining of co-evolving time sequences. In SIGMOD, pages 193-204, 2014.

Non Patent Literature 17: Y. Matsubara, Y. Sakurai, and C. Faloutsos. The web as a jungle: Non-linear dynamical systems for co-evolving online activities. In WWW, pages 721-731, 2015.

Non Patent Literature 18: Y. Matsubara, Y. Sakurai, C. Faloutsos, T. Iwata, and M. Yoshikawa. Fast mining and forecasting of complex timestamped events. In KDD, pages 271-279, 2012.

Non Patent Literature 19: Y. Matsubara, Y. Sakurai, B. A. Prakash, L. Li, and C. Faloutsos. Rise and fall patterns of information diffusion: model and implications. In KDD, pages 6-14, 2012.

Non Patent Literature 20: H. Mei and J. Eisner. The neural hawkes process: A neutrally self-modulating multivariate point process. In NIPS, pages 6757-6767, 2017.

Non Patent Literature 21: Y. Qin, D. Song, H. Chen, W. Cheng, G. Jiang, and G. W. Cottrell. A dual-stage attention-based recurrent neural network for time series prediction. In IJCAI, pages 2627-2633, 2017.

Non Patent Literature 22: T. Rakthanmanon, B. J. L. Campana, A. Mueen, G. E. A. P. A. Batista, M. B. Westover, Q. Zhu, J. Zakaria, and E. J. Keogh. Searching and mining trillions of time series subsequences under dynamic time warping. In KDD, pages 262-270, 2012.

Non Patent Literature 23: J. Rissanen. A Universal Prior for Integers and Estimation by Minimum Description Length. Ann. of Statist, 11(2): 416-431, 1983.

Non Patent Literature 24: Y. Sakurai, Y. Matsubara, and C. Faloutsos. Mining and forecasting of big time-series data. In SIGMOD, pages 919-922, 2015.

Non Patent Literature 25: Y. Sakurai, S. Papadimitriou, and C. Faloutsos. Braid: Stream mining through group lag correlations. In SIGMOD, pages 599-610, 2005.

Non Patent Literature 26: I. Sutskever, O. Vinyals, and Q. V. Le. Sequence to sequence learning with neural networks. In NIPS, pages 3104-3112. 2014.

Non Patent Literature 27: Tsungnan Lin, B. G. Horne, P. Tino, and C. L. Giles. Learning long-term dependencies in narx recurrent neural networks. IEEE Transactions on Neural Networks, 7(6): 1329-1338, 1996.

Non Patent Literature 28: P. Wang, H. Wang, and W. Wang. Finding semantics in time series. In SIGMOD Conference, pages 385-396, 2011. Non Patent Literature 29: S. Wang, K. Kam, C. Xiao, S. R. Bowen, and W. A. Chaovalitwongse. An efficient time series subsequence pattern mining and prediction framework with an application to respiratory motion prediction. In AAAI, pages 2159-2165, 2016. Non Patent Literature 30: S. Xiao, J. Yan, X. Yang, H. Zha, and S. Chu. Modeling the intensity function of point process via recurrent neural networks, 2017.

Non Patent Literature 31: R. Zhao and Q. Ji. An adversarial hierarchical hidden markov model for human pose modeling and generation. In AAAI, 2018.

Non Patent Literature 32: Y. Zhou, H. Zou, R. Arghandeh, W. Gu, and C. J. Spanos. Non-parametric outliers detection in multiple time series A case study: Power grid data analysis. In AAAI, 2018.

### SUMMARY OF INVENTION

### Technical Problem

As described above, conventionally, an event forecasting method or system that targets time-series tensor data, requires no prior knowledge of a time-series pattern, and forecasts an event by use of a characteristic pattern of time-series data has not been proposed.

In view of the foregoing, the present invention provides an event forecasting system, method, and storage medium that target time-series tensor data and enable long-term and highly accurate event forecasting through summary processing of data.

### Solution to Problem

An event forecasting system according to the present invention includes a first feature amount extracting unit to continuously extract a model parameter set including a model parameter of a multidirectional dynamic pattern from time-series sensor data continuously collected from a plurality of types of sensors respectively disposed at a plurality of observation objects, a second feature amount extracting unit to sequentially featurize the time-series sensor data into summary information including modeling information and error information obtained when modeling by use of the model parameter set, and a forecasting unit to output a probability of occurrence of a predetermined event at a predetermined time ahead by using the summary information as an input.

In addition, in an event forecasting method according to the present invention, a first feature amount extracting step of continuously extracting a model parameter set including a model parameter of a multidirectional dynamic pattern from time-series sensor data continuously collected from a plurality of types of sensors respectively disposed at a plurality of observation objects and stored in a storage unit, and storing the model parameter set in the storage unit, a second feature amount extracting step of reading the model parameter set and the time-series sensor data from the storage unit, sequentially featurizing the time-series sensor data into summary information including modeling information and error information obtained when modeling, and stores the summary information in the storage unit, and a forecasting step of reading the summary information from the storage unit as an input, and outputs a probability of occurrence of a predetermined event at a predetermined time ahead.

Moreover, a non-transitory computer readable storage medium storing a program according to the present invention causes a computer to implement a first feature amount extracting a first feature to continuously extract a model parameter set including a model parameter of a multidirectional dynamic pattern from time-series sensor data continuously collected from a plurality of types of sensors respectively disposed at a plurality of observation objects, extracting a second feature to sequentially featurize the time-series sensor data into summary information including modeling information and error information obtained when modeling by use of the model parameter set, and forecasting to output a probability of occurrence of a predetermined event at a predetermined time ahead by using the summary information as an input.

According to the present invention, the time-series sensor data is continuously collected from the plurality of types of sensors respectively disposed at the plurality of observation objects, and extraction of the model parameter set including the model parameter of the multidirectional dynamic pattern from collected time-series sensor data is continuously performed by the first feature amount extracting unit. Subsequently, the time-series sensor data is sequentially featurized into the summary information including modeling information and error information obtained when modeling by use of the model parameter set, by the second feature amount extracting unit. Then, the probability of occurrence of a predetermined event at a predetermined time ahead by using the summary information as an input is outputted by the forecasting unit. Therefore, no prior knowledge with respect to the time-series pattern included in the time-series sensor data is required, and a point of variation and potential behavior of a pattern (a regime) are grasped, for example, in terms of time transitions and a multidirectional viewpoint between the observation objects. In addition, a characteristic pattern of the large-scale time-series sensor data is discovered, which enables long-range event forecasting by use of the characteristic pattern. It is to be noted that the placement of sensors may be directly installed on an observation object or may be installed so as to remotely observe the observation object.

### Advantageous Effects of the Disclosure

According to the present invention, a feature amount is multidirectionally extracted and summarized from time-series sensor data, which enables long-term and highly accurate event forecasting with a simple configuration.

### BRIEF DESCRIPTION OF DRAWINGS

FIG. 1 is an entire block diagram showing one embodiment of an event forecasting system according to the present invention.

FIG. 2A to FIG. 2D are views showing an example of a processing status of information captured from smart factory data to which the present invention is applied, FIG. 2A shows original sensor data,

FIG. 2B shows a pattern detection result from original data, FIG. 2C shows a typical example of a regime based on the original data, and FIG. 2D is a view showing a case in which an emergency stop is made after a predetermined time based on the original data.

FIG. 3 is a view showing an overview of a proposed model according to the present invention.

FIG. 4 is a transition diagram to illustrate a basic concept of a proposed algorithm according to the present invention.

FIG. 5 is a comparison view of accuracy when the number lₛ of forecast ahead steps is varied.

FIG. 6 is a comparison view of forecast accuracy when a window width of a mini batch used during network learning is varied.

FIG. 7 is a comparison view showing precision (Precision) and recall (Recall) of a forecast result.

FIG. 8 is a view showing a variation of the forecast accuracy of the present forecasting system with respect to the number m of detection segments.

FIG. 9 is a view showing a relationship between the number of learning samples and the forecast accuracy.

FIG. 10A to FIG. 10C are views showing computational cost of the present forecasting system when each of the number w of facilities (see FIG. 10A), the number d of sensors (see FIG. 10B), and a sequence length n (see FIG. 10C) are varied.

### DESCRIPTION OF EMBODIMENTS

The present invention preferably relates to an event forecasting method for large-scale time-series sensor data. The present invention, as an example, relates to a technology to integrally analyze and summarize a multidirectional time-series pattern based on a plurality of viewpoints from, for example, factory facility sensor data configured by a set of three attributes (facility, sensor, and time) to perform long-term future event forecasting. More specifically, when the time-series data configured by the actual measured values of the sensor data such as rotational speed, operating voltage, and facility temperature in each facility installed in a factory is given, (a) a basic time-series pattern, a common pattern between facilities, or a facility-specific pattern is extracted and statistically summarized, so that (b) long-range event forecasting is performed. Furthermore, these processes are (c) linear with respect to data size. It is to be noted that, as described below, an experiment using real data confirmed that the present forecasting method multidirectionally captured a characteristic time-series pattern included in the sensor data of a factory facility and performed long-term event forecasting, and, furthermore, as described below, clearly showed that significant accuracy and performance improvement were achieved, in comparison with the latest existing method (a comparative example).

In other words, the present forecasting system forecasts an event that will occur in the future by multidirectionally capturing the number of typical patterns (hereafter referred to as a regime) and the point of variation that are included in the time-series data, and accurately grasping the operational status of a system. More specifically, when large-scale time-series sensor data collected from a plurality of sensors in facilities at a plurality of locations is given, an event after a predetermined time, that is, an lₛ-step ahead event is forecasted.

Further specifically, (a) a multidirectional pattern and a point of variation of the multidirectional pattern are detected in the sensor data and summarized as summary information, which (b) provide implementation of long-term and highly accurate forecasting. Furthermore, (c) these processes are performed at a high speed.

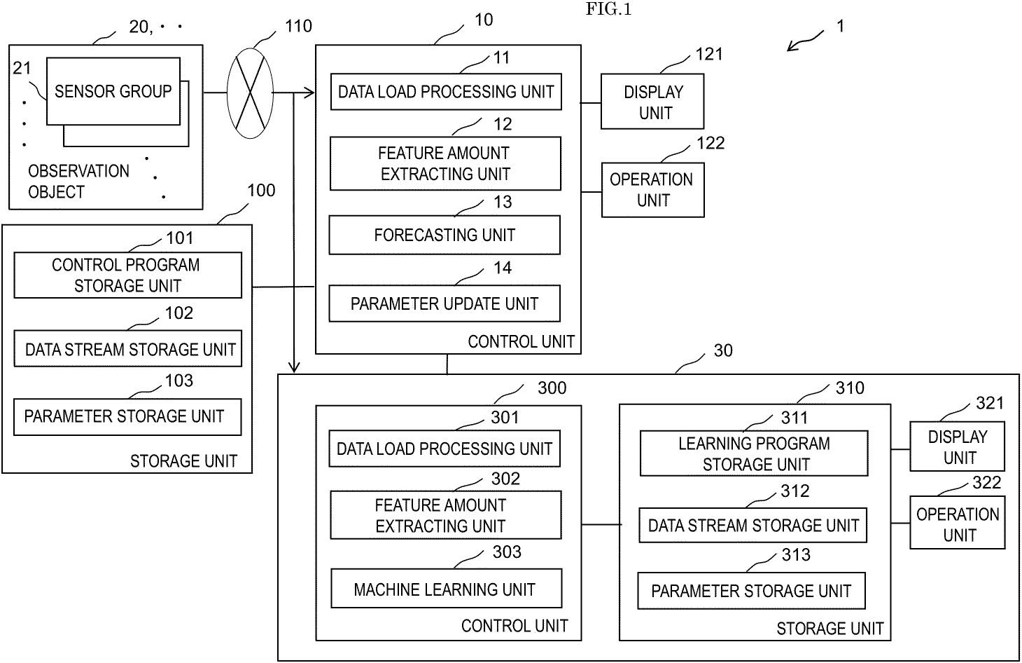

Hereinafter, the present invention will be described with reference to drawings. FIG. 1 is an entire block diagram of an event forecasting system (hereinafter referred to as a forecasting system 1) according to the present invention. The present forecasting system 1 includes a configuration to collect, through a wired or wireless communication channel, large-scale time-series sensor data related to an operational status from each sensor group 21 installed in an observation object 20, ..., as a plurality of facilities of a factory or the like, for example, and a computer having a control unit 10 including a processor (a CPU) to extract a feature amount from each captured time-series data and further executes event forecasting processing after a predetermined time. In addition, in the present embodiment, machine learning is used, and a parameter applied to forecasting processing is updated through the machine learning. The details of FIG. 1 will be described below.

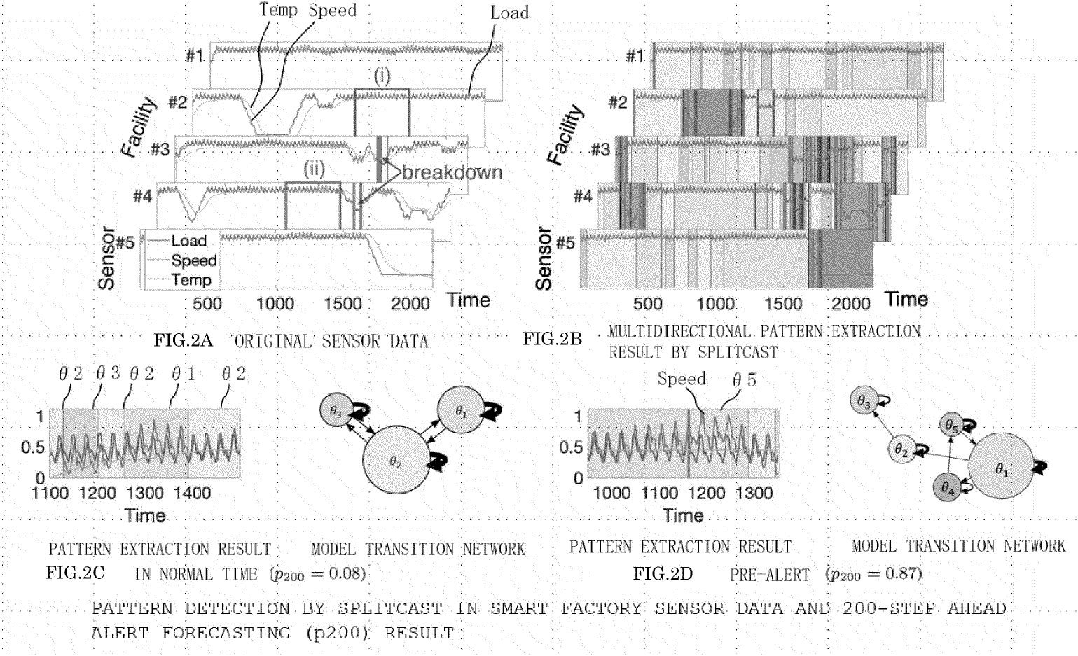

First, a specific example described in FIG. 2A to FIG. 2D will be described for understanding of the forecasting processing. FIG. 2A to FIG. 2D show sensor data from a smart factory as an example of an observation object 20 (FIG. 1), that is, information used (for inputting) for the forecasting processing. FIG. 2A shows original sensor data configured by three sensor values (Rotation Speed: Speed, Operating Voltage: Load, and Facility Temperature: Temp) collected from five facilities (#1 to #5) as an example of each sensor group 21 (FIG. 1). In FIG. 2A, an area painted with a black rectangle indicates that a corresponding facility is under emergency shutdown. It is to be noted that a waveform of the operating voltage: Load in FIG. 2A basically overlaps with a waveform of the rotational speed: Speed. FIG. 2B shows a pattern extraction result from original data by the present forecasting system. Vertical lines in FIG. 2B indicate a time when the time-series pattern varies, and segments belonging to the same regime are represented by the same shade of color. The forecasting system 1, by simultaneously analyzing time-series data obtained from a plurality of facilities, is able to detect a multidimensional pattern, that is, not only time transition of a pattern in each facility but patterns that are common or different between the facilities.

FIG. 2C and FIG. 2D show typical examples with and without an emergency stop after lₛ=200 steps (about 17 minutes), from the original data. The left side of FIG. 2C and FIG. 2D shows a segmentation result. The right side shows θ₁ to θ₅ each representing a common time-series pattern (that is, a regime), and a state of the transitions is visualized. The value of p200 is a 200-step ahead emergency stop probability that the present forecasting system outputted, when a subsequence and a pattern detection result of the partial sequence that correspond to the view on the left side of FIG. 2C and FIG. 2D are given. In the view on the right side of FIG. 2C and FIG. 2D, a thick arrow is displayed between regimes from which more transitions were detected. In addition, the size of a circle indicates the size of a period during which the regime occurs. FIG. 2D shows that the rotational speed Speed increases (θ₅) before the facility comes to an emergency stop, and the trend is represented by the appearance of transitions of regimes θ₄ and θ₅. In practice, the present forecasting system 1 accurately forecasts an emergency stop, and p200 shows a high value. In other words, by detecting a potential pattern in the data, not only can a process leading to the emergency stop be analyzed multidirectionally, but longer-term and highly accurate forecasting is enabled by using the summary information. It is to be noted that FIG. 2C shows a transition without a sign of an emergency stop such as regimes θ₂, θ₃, θ₂, θ₁, and θ₂, and p200 also shows a low value.

As an example of the factory facility sensor data handled by the present forecasting system 1, three types of sensor data at 55 facilities operating on Oct. 1, 2017, at Mitsubishi Heavy Industries Engine & Turbocharger Corporation is shown. The present data is represented as a set of three attributes (facility, sensor, time), each being configured by w facilities, d types of sensors, and n periods (units of 5 seconds, for example). Such sensor data is able to be represented as a third-order tensor X ∈ R^{w×d×n}, and an element Xᵢⱼ(t) of the tensor X shows a measurement value at a j-th sensor of the i-th facility at time t. In the present embodiment, such sensor data is called a multidimensional time-series tensor.

The present forecasting system 1 forecasts an lₛ-step ahead facility alert from a given time-series tensor X, and processing required for achievement will be shown below.

In other words, when a time-series tensor X (tₛ:tₑ) is given, an lₛ-step ahead alert label y(tₑ+lₛ) is forecasted based on the following formula (F1).

$${\text{y(t}}_{\text{e}} {\text{+l}}_{\text{s}} \text{)} \approx {\text{F(X(t}}_{\text{s}} {\text{:t}}_{\text{e}} \text{))}$$

It is to be noted that tₛ:tₑ represents a window (a predetermined period in a past direction from the present time) of a sequence used for forecasting, and F is a proposed model.

Herein, in order to forecast the alert label y(tₑ+lₛ) with high accuracy, a model based on a probabilistic model and deep learning is constructed to extract, from the given sensor data, high-dimensional and non-linear dynamic characteristics that cause a failure (an alert), for example. Specifically, the present forecasting system 1 executes the following three types of processing: (P1), (P2), and (P3).
(P1) Multidirectional detection of a potential dynamic pattern
(P2) Feature extraction based on a dynamic pattern
(P3) lₛ-step ahead long-term forecasting

First, each processing (P1), (P2), and (P3) will be described in relation to FIG. 1. In FIG. 1, the control unit 10 is connected to a storage unit 100, a display unit 121 to mainly perform display of a window to be described below, for example, and an operation unit 122 to receive instructions from the outside. The storage unit 100 includes a control program storage unit 101, a data stream storage unit 102 to store time-series sensor data to be inputted from each sensor group 21, and a parameter storage unit 103 to store a parameter (such as a weight of each edge) of a neural network model to configure an artificial intelligence (AI) applied to forecasting processing. The control program storage unit 101 stores program data and various types of required operational expression data for executing event forecasting processing to be described below. Moreover, the storage unit 100, in addition to the data stream storage unit 102, has a work area (a storage unit) to temporarily store each data obtained during execution of each processing to be described below of “ (P1) Multidirectional detection of a potential dynamic pattern,” “(P2) Feature extraction based on a dynamic pattern,” and “ (P3) lₛ-step ahead long-term forecasting.”

The control unit 10, when a control program is executed, functions as a data capturing processing unit 11, a feature amount extracting unit 12, a forecasting unit 13, and a parameter update unit 14. The data capturing processing unit 11 captures time-series sensor data from the sensor group 21 of each observation object 20 (each facility in a factory) via the network 110.

The feature amount extracting unit 12 executes the processing to be described below of “ (P1) Multidirectional detection of a potential dynamic pattern,” and “(P2) Feature extraction based on a dynamic pattern.” The forecasting unit 13 executes the processing of “ (P3) lₛ-step ahead long-term forecasting.” In the present embodiment, the forecasting unit 13 performs forecasting processing by applying the parameter from the parameter storage unit 103. The details of each processing will be described below.

A machine learning apparatus 30 includes a control unit 300 including a computer with a built-in processor, and a storage unit 310, and also includes a display unit 321 and an operation unit 322. The storage unit 310 includes a learning program storage unit 311, a data stream storage unit 312, and a parameter storage unit 313. The data stream storage unit 312 captures time-series sensor data to be inputted from each sensor group 21 via communication or through external memory or captures data once written to the data stream storage unit 102, and stores the data.

The control unit 300, when a learning program from the learning program storage unit 311 is executed, functions as a data capturing processing unit 301, a feature amount extracting unit 302, and a machine learning unit 303. The data capturing processing unit 301, as with the data capturing processing unit 11, is further able to appropriately set automatically or manually a period of time (for the most recent one week, for example) for capturing captured data as appropriate. The feature amount extracting unit 302 is provided as necessary, and checks the processing by appropriately adjusting the conditions of the above processing (P1) and (P2) according to a change in a factory facility and other changes in a situation, for example.

The machine learning unit 303 performs machine learning by applying “learning with a teacher,” or the like, for example, preferably with respect to the time-series sensor data for the most recent predetermined period, stores a parameter being a learning result in the parameter storage unit 313, and updates the parameter storage unit 103 through the parameter update unit 14 as needed, or by receiving instructions from the operation unit 322 of the machine learning apparatus 30. It is to be noted that machine learning is able to employ various aspects in addition to the aspect of the machine learning apparatus 30 of a different body. For example, input data may be retrieved for a predetermined period from the data stream storage unit 102. In addition, an aspect in which learning is executed by use of the forecasting unit 13, by mainly using a system breakdown period (at night, for example) to update a parameter being a learning result may be employed.

Next, an overview of a “proposed model” and a required definition are shown as in Table 1.

Table 1

Symbols and definitions

| | |
|---|---|
| SYMBOLS | DEFINITIONS |
| w | NUMBER OF FACILITIES |
| d | NUMBER OF SENSORS |
| n | TIME SERIES LENGTH |
| X | MULTIDIMENSIONAL X ∈ R^{w×d×n} TIME SERIES TENSOR |
| y | LABEL SET Y = {y₁,...,y_{w}} |
| m | NUMBER OF SEGMENTS |
| S | SEGMENTSET CONTAINED IN X S={_{s1,...,sm}] |
| k₁ | NUMBER OF POTENTIAL STATES IN i-TH REGIME |
| θ₁ | MODEL PARAMETER FOR i-THREGIME |
| r | NUMBER OF REGIMES |
| Θ | r REGIME SETS Θ = {θ₁,...,θᵣ,Δ_{r×r}} |
| Δ_{r×r} | REGIMETRANSITION MATRIX $Δ = {\left\{{δ}_{i , j}\right\}}_{i , j = 1}^{r}$ |
| F | SEGMENT MEMBERSHIP F= {f₁, ... , fₘ } |
| Z | POTENTIAL STATE Z TENSOR Z = {Z₁,...,Z_{w}} |
| ε | ERROR TENSOR ε = {E₁ ,... ,E_{w}} |
| Cost_{M}(M) | MODEL DESCRIPTION COST |
| Cost_{C}(X\|M) | CODING COST OF X BY M |

### Proposed Model

### (P1) Multidirectional Detection of a Potential Dynamic Pattern

When a multidimensional time-series tensor X is given, the present forecasting system first divides X into m segment sets S = {S₁, ..., Sₘ}, and captures the feature. Sᵢ includes a starting point tₛ, end point tₑ, and facility number of the i-th segment (that is, Sᵢ = {tₛ, tₑ, facility ID}), and each segment is assumed to have no overlap. Then, discovered segment sets are classified into groups of similar segments. In the present forecasting system, these groups are referred to as a “regime.”

### Definition 1 (Regime)

r is set as the number of optimal segment groups. Each segment s is assigned to one of the segment groups. Furthermore, a new segment membership is defined to represent a regime to which each segment belongs.

### Definition 2 (Segment Membership)

When a multidimensional time-series tensor X is given, F = {f₁, ..., fₘ} is set as a sequence of m integers, and fᵢ is set as the number of the regime to which the i-th segment belongs (1 <= fi <= r) .

As a result, the multidimensional time-series tensor X is able to be represented as {m, r, S, Θ, F} by m segments and r regimes. Next, the present forecasting system, based on obtained regime information, statistically models the multidimensional time-series tensor X, and extracts an important feature.

### (P2) Feature Extraction Based on a Dynamic Pattern

Each regime is represented by statistical model Θ = {θ₁, ..., θᵣ, Δ_{r×r}} .In the present research, in order to represent the behavior of a multidimensional time-series tensor X, a Hidden Markov Model (HMM) is used. The HMM is a type of a probabilistic model in which a Markov process with a hidden state is assumed, and is widely used as a time-series processing method in various fields including speech recognition. The HMM is represented by a set of three probabilities of initial probability Π = {Πᵢ]^{k}ᵢ₌₁, transition probability A = {aᵢⱼ}^{k}ᵢ, ⱼ₌₁, and output probability B = {bi(x) }^{k}ᵢ₌₁ (that is, θ = {Π, A, B}). Herein, k denotes the number of latent states of the HMM. In the present forecasting system, the output probability B is assumed to be generated from multidimensional Gaussian distribution. This represents a sequence of multidimensional vectors in a probabilistic model (that is, B~{N(µᵢ, σ²i) }^{k}ᵢ₌₁) . When the model parameter θ = {Π, A, B} of the HMM and a certain user sequence X are given as input data, the likelihood P (X|θ) of X is calculated as in the following formula (Mathematical Formula 1).

$$\begin{matrix}P \left(X \left|θ\right)\right) = {max}_{1 \leq i \leq k} \left\{{p}_{i} \left(n\right)\right\} \\ {p}_{i} \left(t\right) = \left\{\begin{matrix}{π}_{i} ⋅ {b}_{i} \left({x}_{1}\right) & \left(t = 1\right) \\ {max}_{1 \leq j \leq k} \left\{{p}_{j} \left(t - 1\right) ⋅ {a}_{j i}\right\} ⋅ {b}_{i} \left({x}_{t}\right) & \left(2 \leq t \leq n\right)\end{matrix}\right)\end{matrix}$$

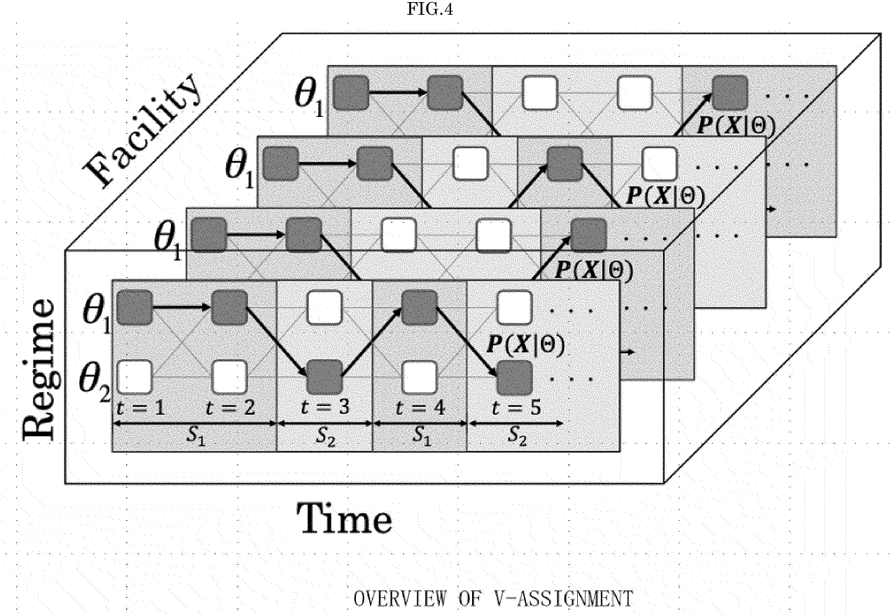

Herein, pi(t) denotes the maximum probability of a latent state i at time t, and n is the sequence length of X. This likelihood, based on the transition diagram shown in FIG. 4, is calculated by use of the Viterbi algorithm (Non Patent Literature 7) being a type of dynamic programming. Herein, the regime transition matrix Δ_{r×r} is further introduced as a new concept.

### Definition 3 (Regime Transition Matrix)

Δ_{r×r} is called the transition matrix of r regime groups. Herein, an element δᵢⱼ ∈ Δ denotes the transition probability from the i-th regime to the j-th regime. In other words, 0 ≤ δᵢⱼ < 1, with the condition that Σⱼδᵢⱼ = 1. By use of the above model, the multidimensional time-series tensor X is summarized and featurized by latent state series Z of the HMM and an error ε obtained when modeling, as will be shown below, to achieve highly accurate and long-term forecasting.

### Definition 4 (Latent State Tensor)

The latent state series Z = {Z₁, ..., Z_{w}} of the HMM for every facility is called a latent state tensor. Herein, Zi = { Zᵢⱼ (1), ..., Zᵢⱼ (n) }^{d}ⱼ₌₁, and Zᵢⱼ (t) are configured by a pair {µ, σ} of mean and variance of a data set x belonging to the same latent state as self.

### Definition 5 (Error Tensor)

The error ε = {E₁, ..., E_{w}} obtained when a multidimensional time-series tensor X is modeled by a latent state tensor Z is called an error tensor. The present forecasting system assumes the output probability B of the HMM follows the multidimensional Gaussian distribution, so that an error eᵢⱼ (t) ∈ Eᵢ at time t in the j-th sensor of the i-th facility is represented as the following (Mathematical Formula 2).

$${e}_{i j} \left(t\right) = P \left({X}_{i j} \left(t\right) \left|{z}_{i j} \left(t\right)\right)\right) \sim {N \left(μ , {σ}^{2}\right)}_{μ , σ ∈ {z}_{i j} \left(t\right)}$$

In other words, the time-series tensor X is summarized by a latent state tensor Z and an error tensor such that X ≈ IGPDF (Z, ε) based on the regime information {m, r, S, Θ, F} obtained by (P1), and important features are extracted. Herein, IGPDF (Inverse Gaussian Probability Density Function) represents the inverse function of the probability density function in the Gaussian distribution.

### (P3) ls-Step Ahead Long-Term Forecasting

In conclusion, the above formula (F1) is rewritten as the following formula (3).

$$Y \left({t}_{e} + {l}_{s}\right) \approx F \left(\left\{Z \left({t}_{s} : {t}_{e}\right) , E \left({t}_{s} : {t}_{e}\right)\right\}\right)$$

Herein, F represents a forecasting model. In other words, when a time-series tensor X is given, a proposed method extracts the important feature by summarizing X by the latent state tensor Z and the error tensor s, and applies a proposed model F to the important features, and performs an lₛ-step ahead long-term forecasting with high accuracy.

### Algorithm About Processing (P1), (P2), and (P3)

The above describes a proposed model to summarize and effectively forecast a multidimensional time-series tensor X. Herein, an algorithm for solving the above formula (F1) will be described. A problem here is whether to determine the number of regimes or segments. The present forecasting system introduces an encoding coding scheme used as a reference for generating an appropriate model, based on the concept of Minimum Description Length (MDL).

### 1. Model Selection and Data Compression

Intuitively, the merit of a model when data was given is able to be represented by the following formula (4).

$$C o s {t}_{T} \left(X ; M\right) = Cos {t}_{M} \left(M\right) + α ⋅ C o s {t}_{C} \left(X \left|M\right)\right)$$

Herein, Cost_{M}(M) denotes a model cost to represent a model M, and Cost_{c}(X|M) denotes a coding cost of a tensor X when the model M is given. α is a weight (α = 1 by default) to the coding cost, and, as the value of α becomes larger, a more accurate model to real data is generated (that is, the number m of segments and the number r of regimes are increased).

### Model Cost

Specifically, the cost of representing all parameter sets of the present forecasting system is configured by the following elements.

$$\begin{matrix}\text{SIZE OF TIME SERIES} \\ {\text{TENSOR X: log}}^{∗} \left(w\right) + {log}^{∗} \left(d\right) + {log}^{∗} \left(n\right) \text{BIT} {}^{* 2} , \\ \text{SEGMENT SET} S : {log}^{∗} \left(m\right) + {\sum }_{i = 1}^{m - 1} {log}^{∗} \left|{g}_{i}\right| \text{BIT} \text{,} \text{REGIME} \\ \text{ASSIGNMENT} F : m log \left(r\right) \text{BIT} \text{,} \text{REGIME PARAMETER SET} Θ \text{;} \\ {\sum }_{i = 1}^{r} C o s {t}_{M} \left({θ}_{i}\right) + C o s {t}_{M} \left(Δ\right) \text{BIT} \text{,}\end{matrix}$$

It is to be noted that the log* shown in the above *2 represents an integral universal code length, and is log* (x) ≈ log₂(x) + log₂log₂ (x) + ... (Non Patent Literature 23). In addition, when a floating point cost is C_{F}, a single regime parameter θ with k states requires a cost of Cost_{M}(θ) = log*(k) + ^{c}_{F}(k+k²+2kd), and a regime transition matrix Δ requires a cost of Cost_{M}(Δ) = C_{F}r².

### Coding Cost

The coding cost of X when the model parameter is given, by negative log-likelihood by information compression using Huffman coding, is able to be represented as the following [Mathematical Formula 6].

$$\begin{matrix}C o s {t}_{C} \left(X \vert θ\right) = {\sum }_{i = 1}^{m} C o s {t}_{C} \left(X \left[{s}_{i}\right] \vert Θ\right) = \\ {\sum }_{i = 1}^{m} - 1 \text{n} \left({δ}_{υ u} ⋅ {\left({δ}_{u u}\right)}^{\vert {s}_{i} \vert - 1} ⋅ P \left(X \left[{s}_{i}\right]\right) \vert \left({θ}_{u}\right)\right) .\end{matrix}$$

Herein, the i-th and (i-1)-th segments are assumed to belong to the u-th and v-th regimes, respectively, and X[si] shows a subsequence configured by the segment si included in X. P(X[sᵢ] | θᵤ) is the likelihood of X[s_{i]} when θᵤ is given. In conclusion, a proposed algorithm determines the number r of time-series patterns included in X and the number m of points of variation of the time-series patterns so as to minimize the above formula (4).

Subsequently, while summarizing the data based on a cost function, a specific algorithm for achieving long-term label forecasting will be detailed.

### 2. Overview of Algorithm

The present forecasting system is configured by the following algorithm.

REGIMEGENRATION (P1): The type and point of variation of a time-series pattern that are included in a tensor X are detected. The dynamics of each time-series pattern is represented as a model parameter Θ to obtain a model parameter set {m, r, S, Θ, F}.

FEATUREEXTRACTION (P2): The original tensor X is represented by a latent state tensor Z and an error tensor ε by use of summary information {m, r, S, Θ, F} of the time-series pattern.

SPLITCAST (P3) : A feature to be a sign of a failure from a subsequence {Z(tₛ:tₑ), ε(tₛ:tₑ)} of a certain window tₛ:tₑ of {Z, ε} is extracted to forecast an lₛ ahead failure label y(tₑ+lₛ).

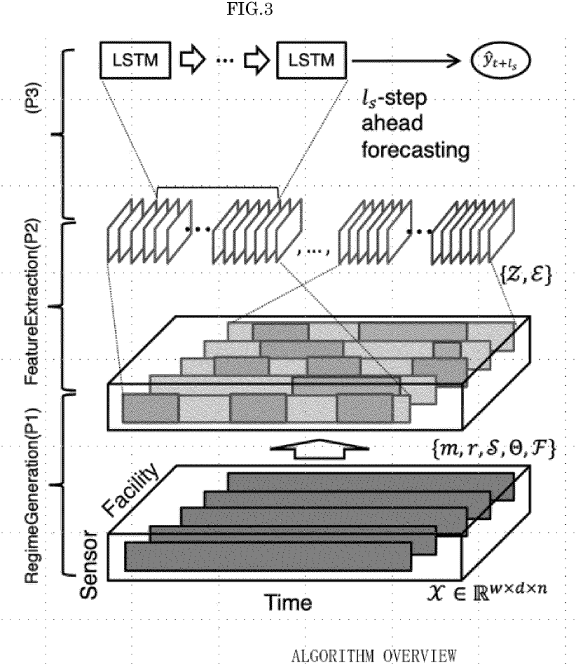

FIG. 3 shows an overview of a proposed model. When a tensor X is given, the proposed method captures time transition and a facility-specific pattern of the time-series pattern of X, and summarizes X by {Z, ε] based on the pattern. Finally, an lₛ-step ahead alert label is forecasted from obtained {Z, ε}, and outputted.

### 3. RegimeGeneration (P1)

Herein, the details of the algorithm will be described. A fundamental question in a time-series analysis is whether or not the time-series data has any hidden internal structure. The multidimensional time-series tensor X treated herein has features from a plurality of viewpoints. In other words, the features are a time domain feature and a facility domain feature. Specifically, the time-series sensor data obtained from a smart factory has a time transition pattern of each process step, and a facility-specific pattern. Then, hereinafter, multidirectional pattern discovery and grouping in which an underlying structure of a given time-series tensor is briefly summarized are simultaneously performed.

Herein, V-Split and H-Split being algorithms for a multidirectional analysis of a time-series tensor are proposed. The V-Split estimates a regime from a viewpoint of a time direction, and the H-Split represents characteristics of each facility as a regime. These two algorithms are performed in any direction, so that an important pattern is multidirectionally discovered efficiently and effectively and is summarized as a regime. Specifically, based on the formula (4), the following two algorithms are repeated.

V-Split: A time-transition pattern from a tensor X and a point of variation of the pattern are detected and divided into two groups (that is, regimes). Model parameters {θ₁, θ₂, Δ} are estimated to those two regimes.

H-Split: A feature for each facility is extracted from a certain regime, that is represented by a tensor X, and is divided into two regimes, and then the model parameter of those regimes is estimated.

The number of regimes changes as r = 1, 2, and ..., with the above algorithms. When a regime θ₀ is divided into the two regimes {θ₁, θ₂}, and a value of the cost function (formula (4) ) is increased, θ₀ is assumed to be optimal and is not further divided. Cost calculation is similarly repeated for all generated regimes, and the above division algorithm is repeated until the cost is no longer reduced. Finally, a segment, regime, and model parameters {m, r, S, Θ, F} when the cost is converged are outputted and RegimeGeneration is ended.

Then, each of the division algorithms the V-Split and the H-Split will be described.

### 1) V-Split

When a multidimensional time-series tensor X is given, the V-Split detects two regimes from a viewpoint of time transition, and estimates those model parameters {θ₁, θ₂, Δ}. In order to generate a highly accurate model, the present forecasting system repeatedly performs detection of a segment/regime and update of a model parameter as follows.

(Phase 1) V-Assignment: When two model parameters are given, two segment sets {S₁, S₂} and a point of variation of a pattern are extracted based on the parameters.

(Phase 2) - ModelEstimation: When two segment sets are given, the model parameters {θ₁, θ₂, Δ} are updated based on the sets.

Table 2

Algorithm 1 V-Split (x)

| | |
|---|---|
| 1: | Input: Tensor X |
| 2: | Output: (m₁, m₂,S₁, S₂, θ₁ , θ₂} |
| 3: | Initialize models θ₁, θ₂, Δ_{2×2}; |
| 4: | while improving the cost do |
| 5: | {m₁, m₂, S₁, S₂} =V-Assignment (X, θ₁, θ₂, Δ); |
| 6: | θ₁ =ModelEstimation (S₁); θ₂ =ModelEstimation (S₂); |
| 7: | Update Δ from S₁ , S₂; |
| 8: | end while |
| 9: | return {m₁, m₂, S₁, S₂, θ₁, θ₂}; |

Algorithm 1 (Table 2) shows an overview of the V-Split. The above algorithm 1 is based on the expected value maximization method (EM: Expectation maximization), and each phase corresponds to E, M step.

First, a case in which a tensor X and two model parameters {θ₁, θ₂, Δ} are given is considered as the simplest subproblem. The V-Assignment is able to detect the point of variation of the pattern of X based on the model parameters of the regime (Steps 5 to 7 in Table 2). In order to describe the basic concept of the proposed algorithm, a transition diagram is shown in FIG. 4. While the transitions of the two regimes {θ₁, θ₂} are connected and the coding costs of the two regimes for each time are compared, the pattern transition between given regimes is estimated. The present algorithm calculates the coding cost Cost_{T}(X|Θ) = -ln P(X|Θ) based on the Viterbi algorithm (Non Patent Literature 7) being a type of dynamic programming. Specifically, the likelihood P(X|Θ) is calculated as the following (Mathematical Formula 7).

$$P \left(\left(X\right| Θ\right) = {max}_{i = 1 , 2} \left\{P {\left(\left(X\right| Θ\right)}_{i}\right\}$$

Herein, P(X|Θ)ᵢ denotes the likelihood of transitioning to the i-th regime θᵢ. As an example, P(X|Θ)₁ is calculated as the following (Mathematical Formula 8).

$$\begin{matrix}P {\left(X \vert Θ\right)}_{1} = {max}_{1 \leq i \leq {k}_{1}} \left(\left\{{p}_{1 ; i} \left(t\right)\right\}\right\} \\ {p}_{1 ; i} \left(t\right) = max \left\{\begin{matrix}{δ}_{21} ⋅ {max}_{u} \left\{{p}_{2 ; u} \left(t - 1\right)\right\} ⋅ {π}_{1 ; i} ⋅ {b}_{1 ; i} ⋅ \left(x \left(t\right)\right) \\ / / \text{regime shift from} {θ}_{2} \text{to} {θ}_{1} \\ {δ}_{11} ⋅ {max}_{j} \left\{{p}_{1 ; j} \left(t - 1\right) ⋅ a {}_{1 ; j i}\right\} ⋅ {b}_{1 ; i} \left(x \left(t\right)\right) \\ / / \text{staying at regime} {θ}_{1}\end{matrix}\right\}\end{matrix}$$

Herein, p_{1;i} (t) denotes the maximum probability of a latent state i of a regime θ₁ at time t, δ₂₁ denotes the regime transition probability from the regime θ₁ to θ₂, maxᵤ{p_{2;u}(t-1) } denotes the probability of being a plausible latent state of θ₂ at the previous time t-1, Π_{1;i} denotes the initial probability of the latent state i of θ₁, b_{1;i} (x (t) ) denotes the output probability of x (t) to the latent state i of θ₁, and then, a_{1;ji} is the transition probability from the latent state i to a latent state j of θ₁. Herein, the probability of being the regime θ₁ at time t = 1 is given by p_{1;i} (1) = δ₁₁Π_{1;i}b_{1;i} (x (t) ) . It is to be noted that the BaumWelch algorithm (Non Patent Literature 1) is used for estimation of the model parameter to calculate the regime transition probability Δ = {δ₁₁, δ₁₂, δ₂₁, δ₂₂} as the following (Mathematical Formula 9).

$${δ}_{11} = \frac{\sum {}_{s \text{} ∈ \text{} \text{} {S}_{1}} \vert s \vert - {N}_{12}}{\sum {}_{s \text{} ∈ \text{} {S}_{1}} \vert s \vert} , {δ}_{12} = \frac{{N}_{12}}{\sum {}_{s \text{} ∈ \text{} {S}_{1}} \vert s \vert}$$

Herein, Σ_{s∈S1} |s| denotes the sum of the lengths of segments belonging to the regime θ₁, and N₁₂ denotes the number of times to switch the regimes from θ₁ to θ₂. δ₂₁ and δ₂₂ are similarly able to be calculated.

### 2) H-Split

The V-Split of the algorithm 1 for capturing the feature in the time direction from the time-series tensor X has been described. As a practical matter, the time-series tensor X has not only time transition of a pattern but also an individual difference for every facility. For example, even in a case in which the same components are processed in some two facilities, individual differences are generated in behavior of sensor data between the facilities for each process step. In the present forecasting system, the H-Split being an algorithm for capturing a facility-specific feature and effectively modeling the feature is proposed. Intuitively, the present algorithm 2, as with the V-Split, estimates an appropriate regime and a model parameter of the regime by repeatedly performing two phases of (Phase 1) regime division and (Phase 2) model estimation. A difference from the V-Split is the algorithm of H-Assignment (Phase 1) for capturing a facility-specific feature. The algorithm 2 (Table 3) shows an overview of the H-Assignment. It is to be noted that the algorithm shown in (Table 3) corresponds to a portion corresponding to the “V-Assignment” in step 5 in (Table 2), and the H-Split may execute (Table 2) with the content replaced with the H-Assignment.

Table 3

Algorithm 2 H-Assignment (X, θ₁, θ₂, Δ)

| | |
|---|---|
| 1: | Input: Tensor X, model parameters {θ₁ , θ₂, Δ} |
| 2: | Output: {m₁, m₂, S₁, S₂} |
| 3: | m₁= 0; m₂ = 0; S₁ = [symbol] ; S₂ = [symbol] ; |
| 4: | for i = 1 to w do |
| 5: | if Cost_{C}(X[i]\|θ₂, Δ) > Cost_{C}(X[i]\|θ₁, Δ) then |
| 6: | S₁ = S₁ ∪ X[i]; |
| 7: | m₁ = m₁ + \|X[i]\|; |
| 8: | else |
| 9: | S₂ = S₂ ∪ X[i]; |
| 10: | m₂ =m₂ + \|X[i]\|; |
| 11: | end if |
| 12: | end for |
| 13: | return {m₁, m₂, S₁, S₂}; |

Unlike a conventional typical clustering algorithm, the H-Assignment effectively extracts a facility-specific pattern. Specifically, when a tensor X and model parameters {θ₁, θ₂} are given, the algorithm 2 calculates the coding cost when a segment of a facility i is assigned to a certain regime θ, as the following (Mathematical Formula 10), and assigns the segment of the facility i to the regime with a smaller cost.

$$\left\{{S}_{θ}\right\} = {arg min}_{θ ∈ {θ}_{1} , {θ}_{2}} C o s {t}_{C} \left(X \left[i\right] \left|θ , Δ\right)\right)$$

Herein, X[i] = {s₁, s₂, ...} is a set of segments of the facility i. In other words, the segments of the same facility are constrained to belong to the same regime.

### 4. FeatureExtraction (P2)

The algorithm for multidirectionally detecting a time-series pattern that varies at any timing from a multidimensional time-series tensor has been described. Next, in order to achieve long-term forecasting of failure occurrence, a feature that shows a cause or sign of a failure from time-series data is to be extracted. In general, sensor data to be collected at high sampling rate contains much noise, and, as the system to be monitored becomes complex, correct behavior of the system becomes difficult to be modeled. Then, in the present forecasting system, a method to abstract X using a feature of a time-series pattern and effectively extract a sign of a failure is proposed. Specifically, when a time-series tensor X and a model parameter set {m, r, S, Θ, F} are given, X is divided into a latent state tensor Z based on a time-series pattern and an error tensor ε obtained when modeling.

When r regime sets Θ = {θ₁, ..., θᵣ} are given at present, data xᵢ(t) = {xᵢⱼ(t) }^{d}ⱼ₌₁ of the facility i is converted into one of the states zᵢ(t) of the regimes in Θ at each time t. Herein, zᵢ(t) denotes a pair {µ, σ} of the mean and variance of all data points belonging to the same state as itself. In other words, the dimension of a latent state tensor is Z ∈ R^{w×2d×n}. Subsequently, when Θ is given, a coding error of the measurement value xᵢⱼ (t) ∈ X of the sensor j of the facility i at time t is represented by a posterior probability p (xᵢⱼ (t) |θ) . In other words, the coding error of the entire time-series tensor X is ε ∈ R^{w×d×n}. Finally, a series X′ ∈ R^{w×3d×n} that combines two features is outputted. By the above processing, a potential behavior in the time-series direction during estimation of a learning model is able to be taken into consideration without losing information on the input data.

### 5. SPLITCAST (P3)

The final goal of the present forecasting system is to perform highly accurate lₛ-step ahead long-term forecasting from a given time-series tensor X. As a typical method of a label forecasting task, a large number of methods based on deep learning have been proposed in recent years. While the methods based on deep learning are able to achieve flexible learning by increasing the number of intermediate layers and the number of units of an intermediate layer, a learning parameter is increased and computation time is increased as the number of layers and the number of units are increased. In addition, there is also a problem of overlearning, and, while a large number of techniques for solving the problem are present, any is based on an empirical rule and requires very fine tuning through human intervention. Therefore, the present forecasting system, by combining a feature extracting method based on a probabilistic model and a deep learning method and learning a characteristic time-series pattern extracted from real data, enables learning in a smaller network, and achieves efficient and effective alert label forecasting while reducing the problem of overlearning.

Specifically, in order to model a state of time evolution of a tensor X′ = {Z, ε }, as shown in FIG. 3, an LSTM (Long-short term memory) (Non Patent Literature 9) is applied. The LSTM is one of the deep learning models that treat an input sample as time-series data, and enable learning of high dimensional non-linear dynamics. The LSTM replaces the units of the intermediate layer of an RNN (Recurrent neural network) with a special structure called a memory unit, which controls a unit value Cₜ at time t and an output value hₜ of the unit by use of three types of an input gate, an output gate, and a forget gate. When the output values of each gate are set to iₜ, ot, and fₜ, respectively, forward propagation of the LSTM is represented by the following formula (Mathematical Formula 11).

$$\begin{matrix}{h}_{t} = {o}_{t} ⊙ σ \left({c}_{t}\right) \\ {0}_{t} = σ \left({W}^{o x} {x}_{t} + {W}^{o h} {h}_{t - 1} + {W}^{o c} {c}_{t} + {b}^{o}\right) \\ {c}_{t} = {f}_{t} ⊙ {c}_{t} {}_{- 1} + {i}_{t} ⊙ σ \left({W}^{h x} {x}_{t} + {W}^{c h} {h}_{t - 1} + {b}^{c}\right) \\ {i}_{t} = σ \left({W}^{i x} {X}_{t} + {W}^{i h} {h}_{t - 1} + {W}^{i c} {c}_{t - 1} + {b}^{1}\right) \\ {f}_{t} = σ \left({W}^{f x} {x}_{t} + {W}^{f h} {h}_{t - 1} + {W}^{f c} {c}_{t - 1} + {b}^{f}\right)\end{matrix}$$

where Θ DENOTES THE PRODUCT OF EACH ELEMENT AND σ (·) DENOTES THE ACTIVATION FUNCTION

In the present forecasting system, the sigmoid function is used for the activation function. The LSTM, as is publicly known, since being able to learn the long-term dependence of an input series given by the memory unit, is thought to extract a feature vector that summarizes the latest operational status of a facility, while storing a feature particularly important to a facility failure in the process of regime transition and state transition inside the regime.

Finally, lₛ-step ahead label forecasting is performed by use of hₜ. In the present embodiment, lₛ-step ahead failure forecasting from the latest subsequence at time t is treated as a 2-class separation task, and an output is set to probability of failure occurrence at time t+lₛ. Therefore, the final output of the present forecasting system is shown in (Mathematical Formula 12) .

$$y t + {l}_{s} = s i g m o i d \left({W}^{y h} {h}_{t} + {b}^{y}\right)$$

In addition, the objective function to be minimized by the model in the present forecasting system is BCE (Binary cross entropy), which is represented as shown in (Mathematical Formula 13) when a batch size during model training is N and an output value in the present forecasting system to each input sample i is y^ᵢ.

$$L = - \frac{1}{N} {\sum }_{i = 1}^{N} {y}_{i} \text{log} {\hat{y}}_{i} + \left(1 - {y}_{i}\right) \text{log} \left(1 - {\hat{y}}_{i}\right)$$

It is important to note here that the present forecasting system, while using a relatively small number of units (= 10) and a model of a simple structure, shows a very high performance, as shown in the following evaluation experiment.

### 1) Theoretical Analysis

An amount of computation in the present forecasting system is linear (O(wdn)) to the data size. Hereinafter, this auxiliary (substantial) theorem will be described.

In each iterative processing, the V-Assignment, the H-Assignment, and the ModelEstimation require the amount of computation of O(wdnk²) for estimation of coding cost and a model parameter. Herein, w denotes the number of facilities, d denotes the number of dimensions, n denotes the length of the time series, and k denotes the number of hidden states in the regime {θᵢ} ^{r}i=1. Therefore, the amount of computation of RegimeGeneration (P1) is O(#iter wdnk²). Herein, the number #iter of iterations and the number k of hidden states are very small constants and can be ignored. Therefore, the amount of computation of RegimeGeneration is O(wdn). In FeatureExtraction (P2), since the latent state of each facility, each sensor, and each time, and the error obtained when modeling are outputted, the amount of computation is O(wdn). Finally, when the obtained model is learned by the LSTM of the number u of units, the amount of computation is 0(u² wdn) . Herein, in the present forecasting system, a complex neural network is not assumed, and the number u of neural network units is a very small constant and can be ignored. Therefore, the amount of computation in the present forecasting system is O(wdn).

### Evaluation Experiment

In order to verify the effectiveness of the present forecasting system, an experiment using real data was conducted by applying the specific example of FIGS. 2A to 2D. The present experiment verified the following items.

(1) Accuracy of the proposed method for long-term forecasting of facility failure

Verification of computation time to real time monitoring of a facility

The experiment was conducted on a Linux (registered trademark) (Ubuntu 18.04 LTS) machine loaded with 128 GB memory and NVIDIA TITAN V 12 GB GPU. In addition, the data set was normalized (z-normalization) by mean and variance values and used.

### 1. Forecast Accuracy of the Present Forecasting System

Failure forecast accuracy to a given time-series tensor was verified. As a comparative example, Logistic regression (LR) (Non Patent Literature 1) being a general binary forecasting model and a Recurrent neural network (RNN) being a recurrent neural network model, a Gated recurrent unit (GRU) (Non Patent Literature 4), and the LSTM were employed. In the LR, a mean value, a variance value, a maximum value, and a minimum value were calculated from the subsequence given as a mini batch when other recursive models were estimated, and label forecasting was performed as a four-dimensional feature vector. In the RNN, the GRU, and the LSTM, the label forecasting was performed by using real data as an input.

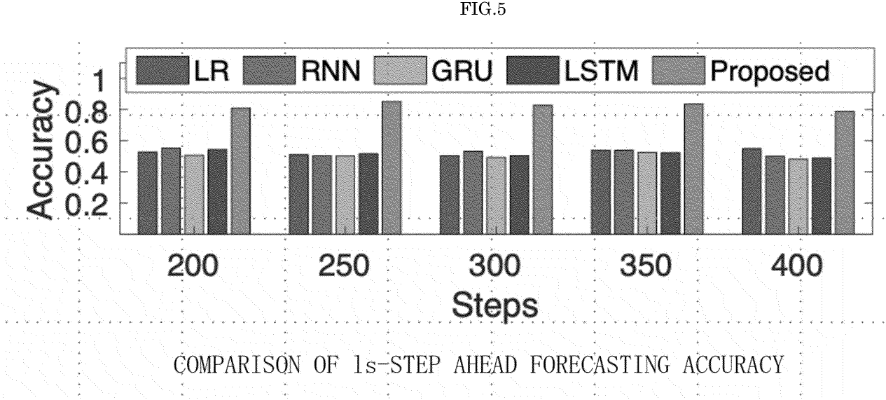

With reference to the present forecasting system, the experiment was performed by using the number of forecasting steps of 200, a window size of 400, and a weight (α =) 1.0 of coding cost as a default. In addition, for all recursive models including the present forecasting system (Proposed, FIG. 5), the number of units of the intermediate layer was set to 10, the number of units of the output layer was set to 5, and Adam (Non Patent Literature 12) was used for the optimization algorithm. Accuracy was used for an evaluation index, and the average values at a time of having performed five-fold cross validation were compared.

The used data set was obtained at 5-second intervals by three sensors of rotational speed (Speed), operating voltage (Load), and facility temperature (Temp), that were installed in 55 factory facilities that had actually operated at Mitsubishi Heavy Industries Engine & Turbocharger Corporation for three months starting in October 2017 and had performed bearing and housing processing. A sliding window generates a sample for learning and omits a sample when the facility itself is not in operation. The number of samples during normal operation was 62983 and the number of samples before the emergency shutdown was 1069, which caused a bias in learning, so that the number of samples during normal operation was matched with the number of samples during the emergency shutdown, and, as a result, 1069 × 2 samples were used for the experiment.

### Forecast Accuracy When the Number of Forecast Ahead Steps is Varied

FIG. 5 is a comparison view of accuracy when the number lₛ of forecast ahead steps is varied. In the figure, the type notation in the comparative example corresponds to the order (left and right) of data display. The present experiment generated a sample for each different lₛ, and performed learning and forecasting. While the comparative example shows similar forecast accuracy (Accuracy = 0.5) to a randomly forecasted case, the present forecasting system shows superior performance under all conditions. This result suggests that the cause of the emergency shutdown is not as simple as a rise in temperature or a drop in operating voltage, but is a complex event with non-linearity. The present forecasting system, since being able to capture the dynamics of each time by considering the time-series pattern included in the real data, succeeded in more effectively extracting factor in emergency stop than other recursive models.

### Forecast Accuracy When a Window Size is Varied

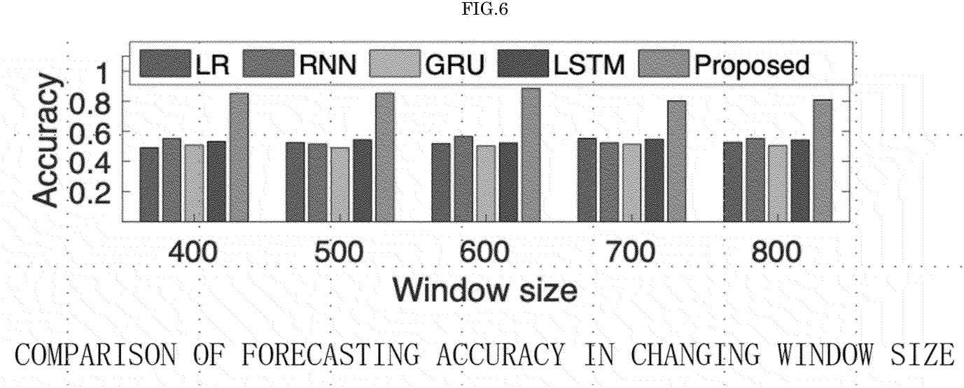

FIG. 6 is a comparison view of forecast accuracy when a window width of a mini batch used during network learning is varied. The present forecasting system stably shows a high performance even with respect to the data of a different window width.

### Precision and Recall of a Forecast Result

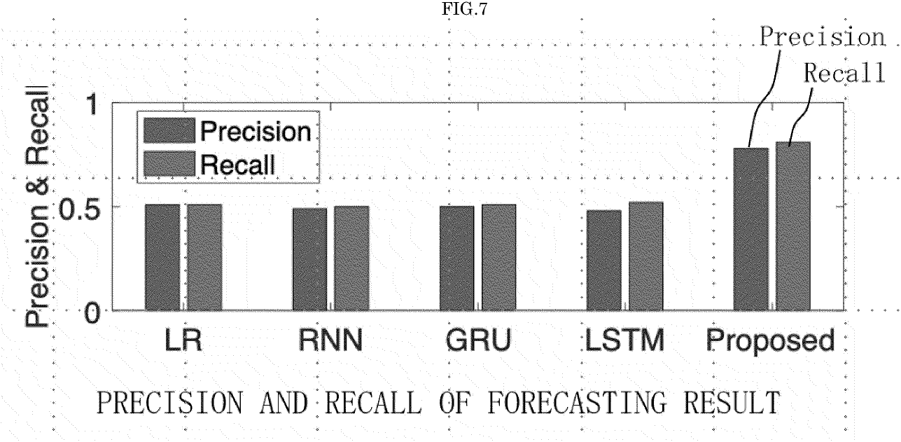

FIG. 7 is a view showing precision (Precision) and recall (Recall) of a forecast result. Precision shows a ratio of the total number of forecasted events to the total number of events of which the correct answer was given. Recall shows a ratio of the number of correct values for all events to the total number of correct answers among the forecasted events. Both, in a case of having high accuracy, approach 1. The present forecasting system also shows the superior performance with respect to both indexes.

### Forecast Accuracy to the Number of Discovery Segments

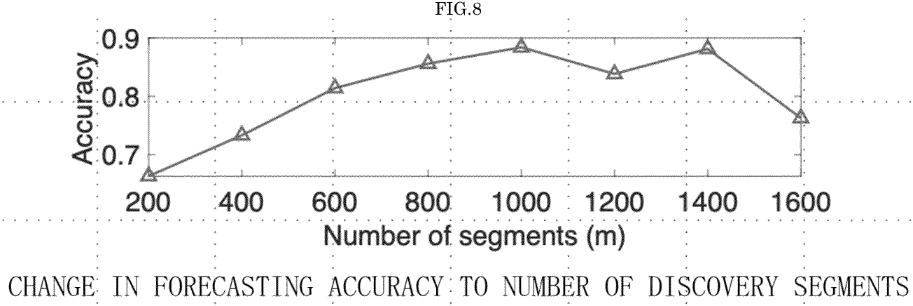

FIG. 8 is a view showing the forecast accuracy of the present forecasting system with respect to the number m of detection segments. The number of detection segments was increased or decreased while α being a weight of the coding cost is varied from 0.1 to 10. As shown in FIG. 8, the forecast accuracy has significantly changed with the number of segments divided by the present forecasting system. In a case in which m is small, sufficient summary information is not able to be obtained from the time-series data, so that the forecast accuracy is reduced. In addition, in a case in which m is large as well, the summary information is closer to the real data, so that the forecast accuracy may also be reduced. From this result as well, the pattern detection from a time-series tensor is considered to be effective in improving the accuracy of failure forecasting. In this experiment, the best result (Accuracy = 0.88) was obtained when m = 1000. In conclusion, the present forecasting system achieved an average accuracy improvement of about 62% over the comparative example.

### Relationship Between the Number of Learning Samples and Forecast Accuracy

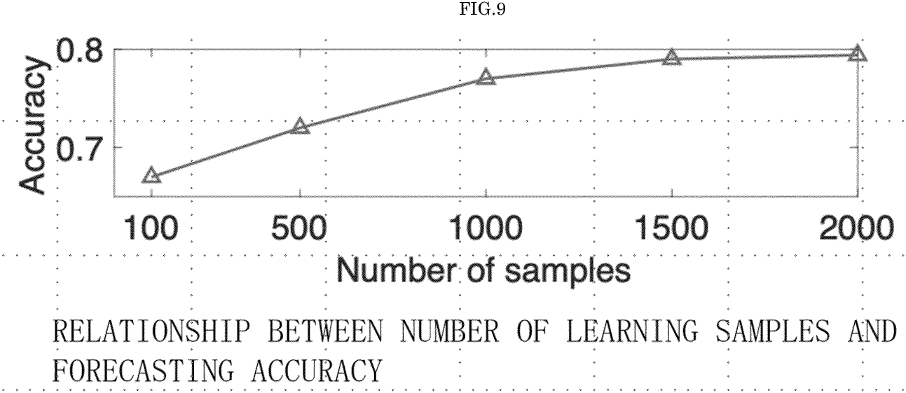

In actual operation, in a case of a small number of learning samples, sufficient accuracy may not be obtained. FIG. 9 is a view showing a relationship between the number of learning samples and the forecast accuracy. The present forecasting system, even with a small number of samples, shows higher performance than the comparative example and is able to forecast a failure event with higher accuracy as the number of learning samples is increased.

### 2. Computational Speed of Proposed Method

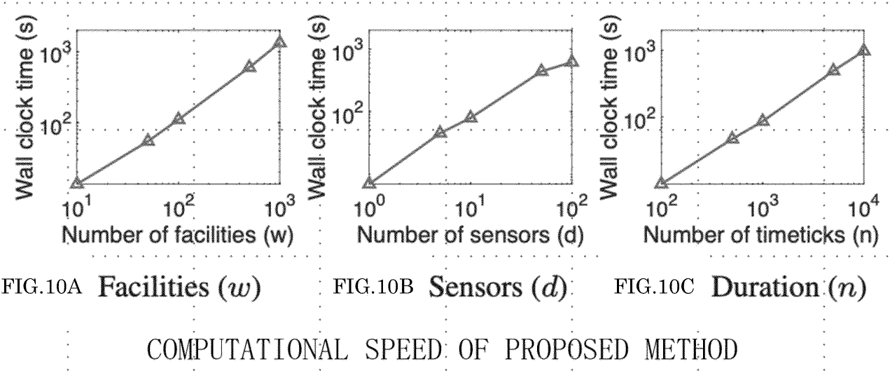

FIGS. 10A to 10C are views showing computational cost of the present forecasting system when each of the number w of facilities (see FIG. 10A), the number d of sensors (see FIG. 10B), and a sequence length n (see FIG. 10C) are varied. More specifically, the computational cost is computation time when the input data is divided into time-series patterns and model learning is completed for 10 epochs. The present forecasting system, since efficiently detecting time-series patterns from a given time-series tensor, has a linear amount of computation in data size (that is, O(wdn)) in all experiments, and was found to be a suitable method for the analysis of large-scale sensor data.

As described above, the present forecasting system performed the experiment using real data obtained, for example, from a factory facility, so that it was confirmed that the present forecasting system was able to appropriately model complex time-series patterns and forecast a long-term failure with high accuracy, and, furthermore, it was able to be confirmed that the present forecasting system achieved a significant improvement in accuracy and performance, compared with the existing comparative example.

It is to be noted that the present invention is applicable not only to the forecasting of an alert event for a factory facility, but also to the forecasting of an alert label such as a failure based on a running condition of each vehicle using various on-board sensors, the forecasting of an alert label based on various types of biological information, and the like. Moreover, the alert label is able to set various alert content according to an application target in addition to a defect, a failure, and reduction in quality. In addition, the forecasting processing is not limited to artificial intelligence (AI), and may employ other methods.

As described above, the event forecasting system according to the present invention preferably includes a first feature amount extracting unit to continuously extract a model parameter set including a model parameter of a multidirectional dynamic pattern from time-series sensor data continuously collected from a plurality of types of sensors respectively disposed at a plurality of observation objects, a second feature amount extracting unit to sequentially featurize the time-series sensor data into summary information including modeling information and error information obtained when modeling by use of the model parameter set, and a forecasting unit to output a probability of occurrence of a predetermined event at a predetermined time ahead by using the summary information as an input.

In addition, in the event forecasting method according to the present invention, a first feature amount extracting step of preferably continuously extracting a model parameter set including a model parameter of a multidirectional dynamic pattern from time-series sensor data continuously collected from a plurality of types of sensors respectively disposed at a plurality of observation objects and stored in a storage unit, and preferably storing the model parameter set in the storage unit, a second feature amount extracting step of preferably reading the model parameter set and the time-series sensor data from the storage unit, preferably sequentially featurizing the time-series sensor data into summary information including modeling information and error information obtained when modeling, and preferably storing the summary information in the storage unit, and a forecasting step of preferably reading the summary information from the storage unit as an input, and preferably outputs a probability of occurrence of a predetermined event at a predetermined time ahead.

Moreover, a non-transitory computer readable storage medium storing a program according to the present invention preferably causes a computer to implement extracting a first feature to continuously extract a model parameter set including a model parameter of a multidirectional dynamic pattern from time-series sensor data continuously collected from a plurality of types of sensors respectively disposed at a plurality of observation objects, extracting a second feature to sequentially featurize the time-series sensor data into summary information including modeling information and error information obtained when modeling by use of the model parameter set, and forecasting to output a probability of occurrence of a predetermined event at a predetermined time ahead by using the summary information as an input.

According to the present invention, the time-series sensor data is continuously collected from the plurality of types of sensors respectively disposed at the plurality of observation objects, and extraction of the model parameter set including the model parameter of the multidirectional dynamic pattern from collected time-series sensor data is continuously performed by the first feature amount extracting unit. Subsequently, the time-series sensor data is sequentially featurized into the summary information including modeling information and error information obtained when modeling by use of the model parameter set, by the second feature amount extracting unit. Then, the probability of occurrence of a predetermined event at a predetermined time ahead by using the summary information as an input is outputted by the forecasting unit. Therefore, no prior knowledge with respect to the time-series pattern included in the time-series sensor data is required, and a point of variation and potential behavior of a pattern (a regime) are grasped, for example, in terms of time transitions and a multidirectional viewpoint between the observation objects. In addition, a characteristic pattern of the large-scale time-series sensor data is discovered, which enables long-range event forecasting by use of the characteristic pattern. It is to be noted that, regarding sensor placement, the sensors may be directly installed on an observation object, or the sensors may be installed so as to remotely observe the observation object.

In addition, the first feature amount extracting unit preferably detects the dynamic pattern by performing a segment and patternization of the segment in a time direction and between the observation objects. With this configuration, a dynamic pattern is multidirectionally extracted, so that an amount of data required for processing is able to be reduced while a reduction in accuracy is significantly reduced or prevented.

In addition, the first feature amount extracting unit preferably performs setting of number of segments by used of a cost function. With this configuration, in segmentation of the time-series sensor data, the number of segments is set to an optimal value in consideration of the amount of data and processing time by the cost function.

In addition, the forecasting unit preferably obtains the probability of occurrence of the predetermined event, based on a parameter that is set in a neural network model. With this configuration, a model of a small and simple structure enables highly accurate forecasting.

Moreover, the forecasting unit preferably applies the LSTM (a Long-short term memory) to the neural network model. With this configuration, the LSTM enables application in a deep learning model and highly accurate long-term ahead forecasting, since long-term dependence of input series is able to be learned.

In addition, the present invention preferably includes a machine learning apparatus to capture the summary information obtained by the second feature amount extracting unit for a predetermined period of time, perform machine learning by a learning forecasting unit having a same configuration as the forecasting unit, and update the parameter obtained as a learning result to the forecasting unit. With this configuration, the forecast accuracy is able to be gradually improved.

### REFERENCE SIGNS LIST

1 event forecasting system
11 data capturing processing unit
12 feature amount extracting unit (first and second feature amount extracting unit)
13 forecast unit
14 parameter update unit
100 storage unit
20 observation object
21 sensor group
30 machine learning apparatus

1. An event forecasting system comprising:
a first feature amount extracting unit to continuously extract a model parameter set including a model parameter of a multidirectional dynamic pattern from time-series sensor data continuously collected from a plurality of types of sensors respectively disposed at a plurality of observation objects;
a second feature amount extracting unit to sequentially featurize the time-series sensor data into summary information including modeling information and error information obtained when modeling by use of the model parameter set; and
a forecasting unit to output a probability of occurrence of a predetermined event at a predetermined time ahead by using the summary information as an input.

2. The event forecasting system according to claim 1, wherein the first feature amount extracting unit detects the dynamic pattern by performing a segment and patternization of the segment in a time direction and between the observation objects.

3. The event forecasting system according to claim 2, wherein the first feature amount extracting unit performs setting of a number of segments by use of a cost function.

4. The event forecasting system according to claim 1, wherein the forecasting unit obtains the probability of occurrence of the predetermined event, based on a parameter that is set in a neural network model.

5. The event forecasting system according to claim 4, wherein the forecasting unit applies an LSTM (a Long-short term memory) to the neural network model.

6. The event forecasting system according to claim 4, comprising a machine learning apparatus to capture the summary information obtained by the second feature amount extracting unit for a predetermined period of time, perform machine learning by a learning forecasting unit having a same configuration as the forecasting unit, and update the parameter obtained as a learning result to the forecasting unit.

7. An event forecasting method comprising:
a first feature amount extracting step of continuously extracting a model parameter set including a model parameter of a multidirectional dynamic pattern from time-series sensor data continuously collected from a plurality of types of sensors respectively disposed at a plurality of observation objects and stored in a storage unit, and storing the model parameter set in the storage unit;
a second feature amount extracting step of reading the model parameter set and the time-series sensor data from the storage unit, sequentially featurizing the time-series sensor data into summary information
including modeling information and error information obtained when modeling, and storing the summary information in the storage unit; and
a forecasting step of reading the summary information from the storage unit as an input, and outputting a probability of occurrence of a predetermined event at a predetermined time ahead.

8. A non-transitory computer readable storage medium storing a program for causing a computer to implement:
extracting a first feature to continuously extract a model parameter set including a model parameter of a multidirectional dynamic pattern from time-series sensor data continuously collected from a plurality of types of sensors respectively disposed at a plurality of observation objects;
extracting a second feature to sequentially featurize the time-series sensor data into summary information including modeling information and error information obtained when modeling by use of the model parameter set; and
a forecasting to output a probability of occurrence of a predetermined event at a predetermined time ahead by using the summary information as an input.

9. The event forecasting system according to claim 1, wherein:
the model parameter set is {m, r, S, Θ, F}; and
the second feature amount extracting unit uses a Hidden Markov Model and summarizes the summary information by latent state series Z and an error ε obtained when modeling, as the modeling information and the error information, where m denotes a number of segments in the time-series sensor data, r denotes a number of regimes in the segments, S denotes a segment set that represents a starting point, end point, and number of the observation objects of each segment, Θ denotes the model parameter of each segment, and F denotes a number of a regime to which the segment belongs.
